(19) United States
(12) Patent Application Publication
(10) Pub. No.: US 2014/0156816 A1
(43) Pub. Date: Jun. 5, 2014

(54) METHOD FOR COMPOSING CONFIGURATION CHANGES IN A NETWORK ELEMENT

(71) Applicants: Rafael Alejandro López Da Silva, Madrid (ES); Gerardo García De Blas, Madrid (ES)

(72) Inventors: Rafael Alejandro López Da Silva, Madrid (ES); Gerardo García De Blas, Madrid (ES)

(21) Appl. No.: 14/115,993

(22) PCT Filed: May 7, 2012
(86) PCT No.: PCT/EP2012/058330

§ 371 Date: Jan. 30, 2014

(30) Foreign Application Priority Data
May 6, 2011 (ES) P201130725

(51) Int. Cl. H04L 12/24

(52) U.S. Cl. CPC H04L 41/0813
USPC 709/221

(57) ABSTRACT

A method for composing configuration changes to be applied to a network element (41) in a distributed way. The method comprises the steps of: at a first server (42), generating a configuration file and signaling the content of said configuration file to the network element (41); according to said content of said configuration file, contacting by said network element (41) a plurality of supporting servers (43 44 45) and downloading from each of said supporting servers (43 44 45) partial pieces of the configuration changes to be applied to the network element (41); combining said partial pieces of configuration changes at said network element (41), thus obtaining a set of resulting configuration changes; applying at said network element (41) said set of resulting configuration changes.

### FIELD OF THE INVENTION

The present invention belongs to the field of network management. In particular, it relates to remote network equipment configuration.

### STATE OF THE ART

Network Management has traditionally relied on a Network Management System (NMS), external to the network devices themselves, to perform all the logic required to produce the configuration for each and every device in the network to be managed. The involvement of the network devices in the network management process has been limited to being able to receive and apply bulks of configuration data as directed by the NMS. FIG. 1 shows the typical schema for remote network equipment configuration, in which the NMS creates the configuration logic and sends it to the network equipment (NE). In particular, first the NMS requests configuration information from the network equipment. Then, the network equipment returns configuration information to the management user according to that request. Then, after obtaining the management information, the NMS completes configuration logic processing at a client and determines whether the configuration may be delivered or not according to a processing result. And finally, the NMS delivers the result of the configuration logic processing to the network equipment.

The process of building the configuration logic for the network equipment evolved so that more intelligence was added to the network equipment. The NMS, instead of sending all the configuration logic to the network equipment, is able to remotely send commands and parameters to the network equipment and the network equipment executes those commands providing the result of that execution to the NMS. This allows the remote execution of indivisible operations in the network equipment. Different approaches exist for this remote execution of operations:
Proprietary Command Line Interfaces (CLI)
Simple Network Management Protocol (SNMP)
NETCONF configuration protocol

A Command Line Interface (CLI) is a mechanism for interacting with an electronic device by typing commands to perform tasks. Each vendor has its proprietary CLI, consisting of an own language for specifying any configuration command to the network devices. For example, CISCO has its Cisco Command Line Interface (http://www.cisco.com/warp/cpropub/45/tutorial.htm, last visit, 11 Nov. 2010). Something common to all devices is that configuration commands in the CLI are organized in a proprietary “configuration tree”. The NMS typically uses a Telnet or SSH connection to gain access to the remote network device and then executes the CLI commands.

The SNMP protocol (RFC 1157, A Simple Network Management Protocol. http://tools.ietf.org/html/rfc1157, Last visit, 11 Nov. 2010) was an attempt to unify the remote configuration of network equipment. It basically provides two methods to configure a device (“get” to read configuration information from the device, and “set” to write configuration parameters into the device). Each configuration parameter has a specific identifier, collected in a Management Information Base (MIB), which must be known by the NMS and the network equipment. MIBs are intended to be generic for all devices; however, the actual situation is that there is a lack of a unified data model for the different, varied and, very often, proprietary functionalities that network devices implement. This has made the CLIs provided by the network devices the preferred choice for the purpose of provisioning configuration data from the NMS to the network devices over other management protocols like SNMP (used for performance and alarm monitoring though).

In 2006 the IETF standardized a new protocol for configuration of network devices, NETCONF (RFC 4741, NETCONF Configuration Protocol. http://tools.ietf.org/html/rfc4741, December 2006. Last visit, 11 Nov. 2010). NETCONF uses XML-based data and a Remote Procedure Call (RPC) layer to invoke methods that reside on the network device. The NMS works as NETCONF client invoking methods on the network devices (the NETCONF server). This model decouples the management protocol (NETCONF) from the methods implemented by the network device. Methods are no longer restricted to “get” or “set” operations as in SNMP, but are programmed and stored in the network device and invoked remotely from the NETCONF client. There exist already network manufacturers providing NETCONF support (e.g. the JunoScript functionality available in Juniper Networks routers, JUNOScript API. http://www.juniper.net/support/products/junoscript/ Last visit, 11 Nov. 2010). In Juniper case, NETCONF support goes along with open programming and processing capabilities in the network device so that the network operator can deploy its own methods to the network device.

Similar to NETCONF, Huawei has a patent application, US 2010/0049837 A1, where the network equipment receives an identifier of a configuration template to be called and configuration parameters. The network equipment calls a configuration template that is locally pre-stored and identified by the configuration template identifier and puts the configuration parameters into the configuration template, so that the network equipment is configured. This process can be seen in FIG. 2, extracted from the mentioned patent application, showing the schematic flowchart of a network equipment configuration method according to an embodiment of that patent application. In particular, the network equipment first receives configuration information. Then, the network equipment finds locally a configuration template to be called according to a configuration template identifier in the configuration information. Finally, the network equipment calls the configuration template and puts the configuration parameters in the configuration information into the configuration template to configure the network equipment.

With respect to that patent application, it is necessary to clarify that the NMS only provides a template identifier. The configuration templates are stored locally in the network device and are not provided by the NMS, as it can be seen in FIG. 3, extracted from the mentioned patent application. In particular, the network equipment management system NMS has a configuration information delivery unit and a configuration template delivering unit; and the network equipment has a receiving unit, a template storing unit and a configuration unit.

All the previous mentioned methods for remote configuration are based on a push model, that is, the initiative to apply configuration changes to the network equipment resides on the NMS, and the NMS indicates explicitly the configuration commands and parameters to be applied to the network equipment.

There exist other different mechanisms for remote configuration based on a pull model.

These mechanisms are commonly known as auto-configuration methods. Examples of these methods are the Dynamic Host Configuration Protocol (DHCP) (RFC2131 Dynamic Host Configuration Protocol. http://tools.ietf.org/html/rfc2131, March 1997. Last visit, 11 Nov. 2010) and the Bootstrap Protocol (BOOTP) (RFC 951 Bootstrap Protocol. http://tools.ietf.org/html/rfc0951, September 1985. Last visit, 11 Nov. 2010). In both protocols, the network device (client) requests configuration parameters to a broadcast address, and the NMS (server) provides them. Typically both protocols are used to obtain an IP address and a remote configuration image. Besides, these protocols have extended options to request other configuration parameters (RFC 2132 DHCP Options and BOOTP Vendor Extensions. http://tools.ietf.org/html/rfc2132, March 1997. Last visit, 11 Nov. 2010; RFC 3046 DHCP Relay Agent Information Option. http://tools.ietf.org/html/rfc3046, March 1997. Last visit, 11 Nov. 2010; RFC 3004 The User Class Option for DHCP. http://tools.ietf.org/html/rfc3004, March 1997. Last visit, 11 Nov. 2010; Dynamic Host Configuration Protocol (DHCP) and Bootstrap Protocol (BOOTP) Parameters. http://www.iana.org/assignements/bootp-dhcp-parameters/. Last visit, 11 Nov. 2010).

The list of configuration parameters, although large enough for enterprise and home environments, is not large and flexible enough to support the whole range of configuration parameters needed for network operators equipment. In fact, operators network do not make use of protocols like DHCP or BOOTP to get part of its configuration, as is done in enterprise and home environments. The approach in operators network is a push model where the NMS has to know about the equipment before it is connected to the network, and, once it is connected, human intervention is required to check that the installation is as expected by the NMS and then let the NMS proceed to configure the equipment.

However, existing network configuration technologies only allow for procedures where the configuration changes to be applied to the network element in an indivisible configuration operation are fully communicated to the network element by a single system, the NMS. This applies to configuration changes resulting from both pull technologies procedures (BOOTP/TFTP procedures) and push procedures (NETCONF, SNMP, CLI configuration).

There is no technical solution that enables the composition of the configuration changes to be applied to the network element in an indivisible configuration operation in a distributed fashion.

### SUMMARY OF THE INVENTION

The present invention tries to solve the above-mentioned drawbacks by means of a procedure for the distributed composition of the configuration changes to be applied to a network node with cooperation of the network node itself.

The procedure is carried out by several entities in a cooperative way. The entities involved are: a first server (or triggering configuration server); the network element; and several additional servers (or supporting configuration servers).

For enabling the distributed composition of the final set of configuration changes, the entities involved in the procedure exchange a new kind of configuration file. In a particular embodiment, this configuration file is called metaconf.

In a first aspect of the present invention, a method for composing configuration changes to be applied to a network element in a distributed way is provided. The method comprises the steps of: at a first server, generating a configuration file and signaling the content of said configuration file to the network element; according to said content of said configuration file, contacting by said network element a plurality of supporting servers and downloading from each of said supporting servers partial pieces of the configuration changes to be applied to the network element; combining said partial pieces of configuration changes at said network element, thus obtaining a set of resulting configuration changes; applying at said network element said set of resulting configuration changes.

The step of signaling a configuration file to the network element is either triggered by the network element itself requesting its configuration to the said first server (pull model) or determined and triggered by a Network Management System configuration logic (push model).

The configuration file preferably comprises a set of URLs for configuration templates and configuration data, wherein said configuration templates URLs include configuration commands with references to variables and the configuration data URLs define values for the variables referenced in the configuration templates.

In that case, the configuration file is preferably configured to identify an anchor point of each template in the configuration tree of the network element.

The configuration file is preferably configured to enable the network element to download the templates and the configuration data specified in the URLs from said plurality of supporting servers.

The configuration file is preferably configured to enable the network element to produce its own complete set of configuration changes by merging the templates at their corresponding anchor point with the configuration data.

In another aspect of the present invention, a system comprising a first server, a network element and a plurality of supporting servers is provided, said system being configured for carrying out the steps of the method previously described.

Finally, the invention provides a computer program comprising computer program code means adapted to perform the steps of the method previously described, when said program is run on a computer, a digital signal processor, a field-programmable gate array, an application-specific integrated circuit, a micro-processor, a micro-controller, or any other form of programmable hardware.

In summary, the invention provides a procedure for the distributed composition of the configuration changes to be applied to a network node in an indivisible configuration operation with cooperation of the network node itself and self-commission of the resulting configuration changes by the network node. Further advantages of the invention will become apparent in view of the following description.

### BRIEF DESCRIPTION OF THE DRAWINGS

To complete the description and in order to provide for a better understanding of the invention, a set of drawings and a table are provided. Said drawings form an integral part of the description and illustrate a preferred embodiment of the invention, which should not be interpreted as restricting the scope of the invention, but rather as an example of how the invention can be embodied. The drawings comprise the following figures:

FIG. 1 shows a typical schema of remote network configuration where the NMS creates the configuration logic and sends it to the network equipment.

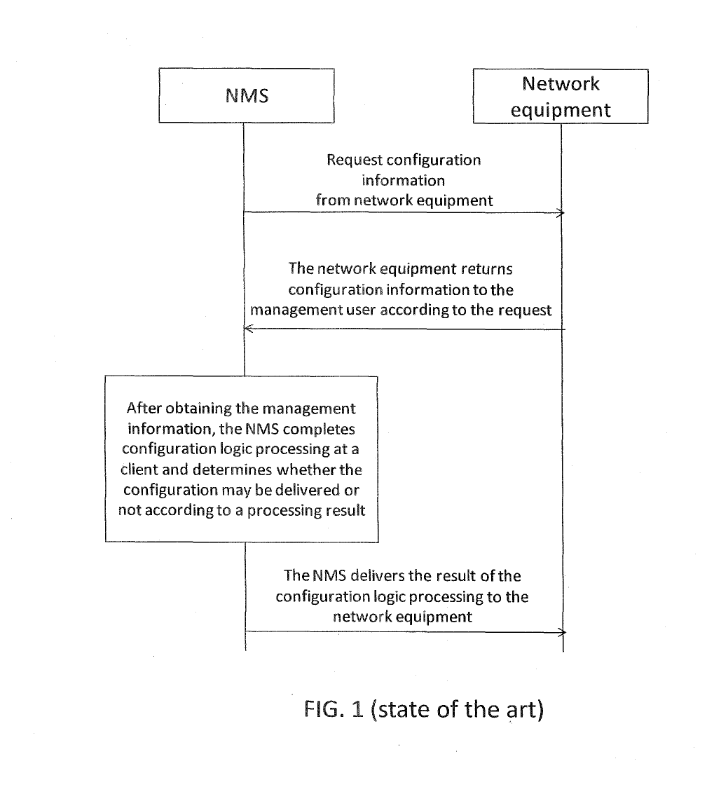

FIG. 2 shows a schematic flowchart of a conventional network equipment configuration method.

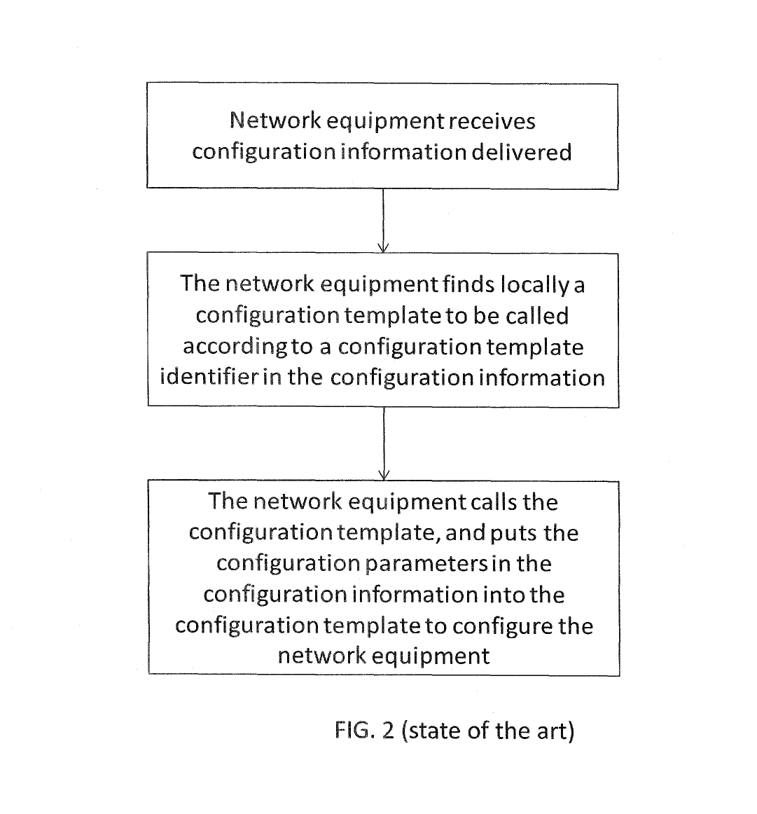

FIG. 3 shows a schematic structural view of conventional network equipment.

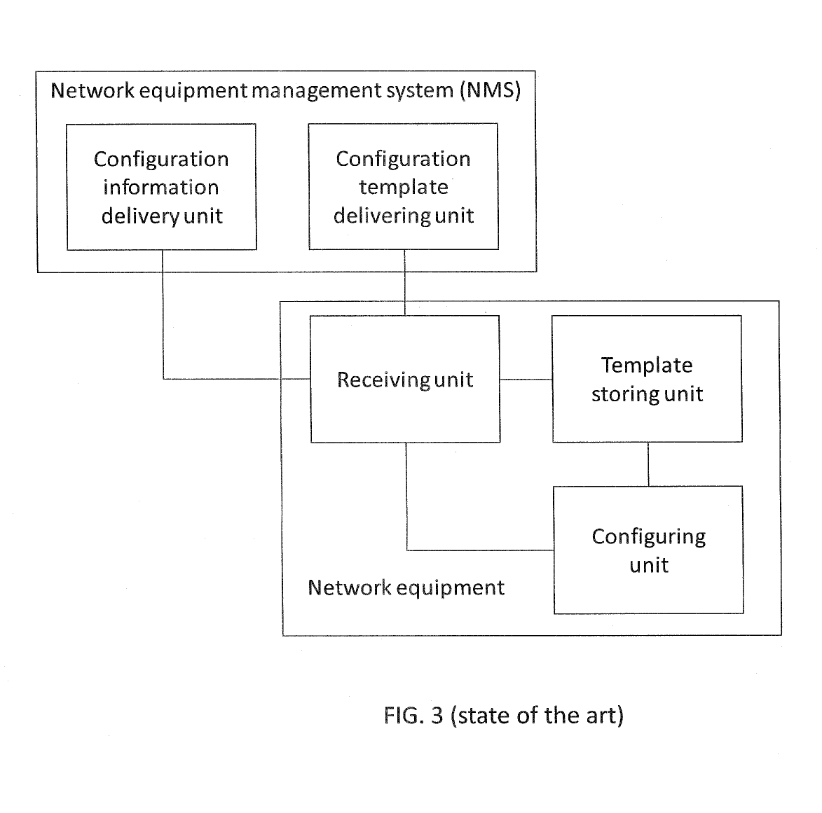

FIG. 4 shows a schema of a network configuration over which the inventive method is implemented.

### DETAILED DESCRIPTION OF THE INVENTION

In this text, the term “comprises” and its derivatives should not be interpreted in an exclusive or limiting sense, i.e. it should not be interpreted so as to exclude the possibility that the element or concept it refers to includes additional elements or steps.

Next, preferred embodiments of the invention are provided in an illustrative way and are not intended to be considered limitations of the present invention. Besides, the present invention covers all possible combinations of the here-indicated particular and preferred embodiments. Skilled people in the art will understand that other objects, advantages and characteristics of the invention are derived in part from the description and in part from the practical implementation of the invention.

The inventive method is described next. It enables the distributed composition of the configuration changes to be applied to a network element in an indivisible operation and their self-commission by the network element.

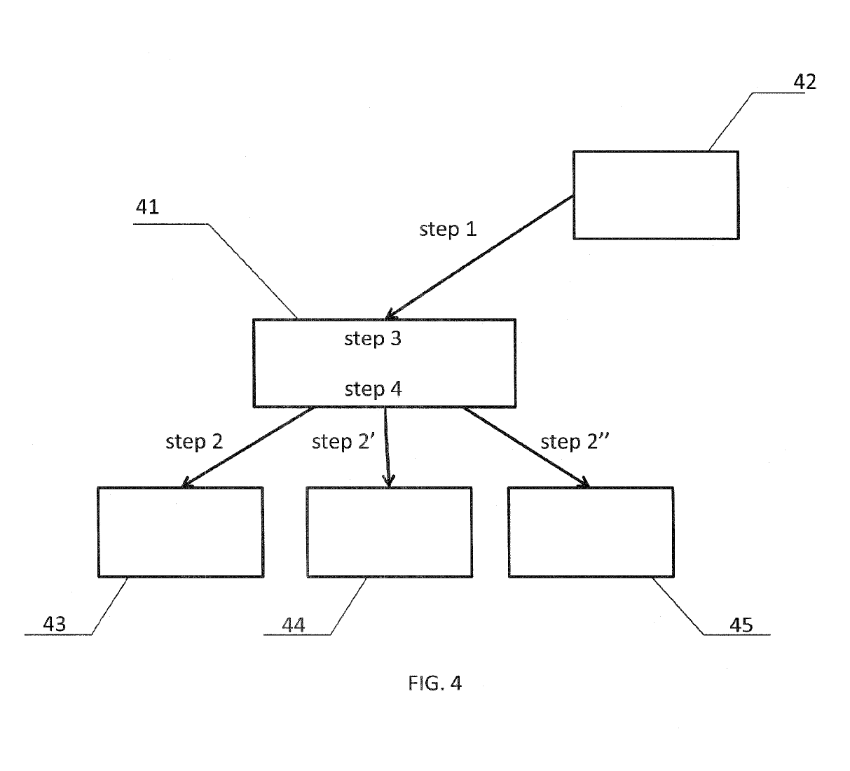

FIG. 4 shows a network element (NE) 41, a first server 42, also called triggering configuration server, and a plurality of additional servers 43 44 45, also called supporting configuration servers. In the particular illustration of FIG. 4, three additional servers 43 44 45 are shown, but there can be more additional servers or less additional servers.

The composition and self commission of the configuration changes is conducted according to the following general scheme:
First, the first server 42 (or triggering configuration server) signals to the network element 41 an intermediate configuration file. In a particular embodiment, this configuration file is called metaconf. This is represented by step 1. This configuration file is used by certain command lines of applications, scripts or executable programs.
With the information in the configuration file (metaconf), the network element 41 contacts several additional supporting servers (supporting configuration servers) 43 44 45 and downloads from each server 43 44 45 partial pieces of the configuration changes to be applied. This is represented by steps 2, 2′, 2″.
The information in the configuration file (metaconf) enables the network element 41 to combine the partial pieces of the configuration changes to be applied in a complete set of configuration changes to be applied to the network element 41 in an indivisible operation. This is represented by step 3.
The network element 41 self applies the complete set of resulting configuration changes in an indivisible configuration operation. This is represented in FIG. 4 by step 4.

### Triggering Event

The triggering event for the configuration procedure, carried out by the first server 42 (triggering configuration server) is outside the scope of the invention. It can be any kind of pull event (e.g. a BOOTP procedure) or it can be triggered as part of the business logic of a network management system.

### Generation of the Configuration File (for Example, Metaconf Generation)

This invention defines a new configuration file (named metaconf) which is built and signaled to the network element 41 by the triggering configuration server 42 and that provides the following features:
It is comprised of a set of URLs (Uniform Resource Locator) for configuration templates and configuration data. The configuration templates URLs include configuration commands with references to variables. The configuration data URLs define values for the variables referenced in the configuration templates.
It identifies the anchor point of each template in the configuration tree of the network element 41.
It enables the network element 41 to download the templates and the configuration data specified in the URLs from several supporting configuration servers 41 42 43, different to the triggering configuration server 42 that provided the configuration file (metaconf) to the network element 41, and making use of the appropriate protocol as signaled in the URL.
It enables the network element 41 to produce its own complete set of configuration changes by merging the templates at their corresponding anchor point with the configuration data.
The configuration file syntax (Metaconf syntax) defines a character as “variable delimiter” so that variables embedded in the configuration templates are recognized by the merging process in the network element 41.
It permits recursion, that is, some URLs of the configuration file (metaconf) are themselves configuration files (metaconfs) and the network device can recursively download the URLs in the next level configuration files (metaconfs) and combine them with the templates and configuration data of previous levels of the recursion.
It allows for the use of vendor proprietary configuration templates and configuration data. For that purpose, the configuration templates and the configuration data are treated as opaque elements (not applied) by the network element 41, as long as a final configuration (no recursion is pending) is not produced by merging configuration templates at their corresponding anchor point with configuration data.

In order for the triggering configuration server 42 to generate the configuration file (metaconf), it has to select the templates and the configuration data URLs, and their corresponding anchor points, to be provided to the network element 41 in the configuration file (metaconf). The criteria by which the triggering configuration server 42 selects the templates and configuration data URLs to be included in the configuration file (metaconf) are outside the scope of this invention.

Next, the method steps of the present invention, shown in FIG. 4, are described in detail:

### Delivery of the Configuration File (Metaconf Delivery) (Step 1)

Once the triggering configuration server 42 has generated a configuration file (metaconf) for the network node or network element 41, it signals the contents of the configuration file (metaconf) to the network element 41.

### Template and Data Acquisition (Step 2) (and Step 2′ Step 2″ . . . )

The network element 41 inspects the configuration file (metaconf) and parses and extracts the URLs contained. The network element 41 downloads the contents (templates and configuration data) from the specified URLs.

The network element 41 inspects the templates downloaded. If any of them is a configuration file (metaconf), the network element 41 recursively downloads the contents from the specified URLs in the configuration file (metaconf).

### Target Configuration Composition (Step 3)

Once the network element 41 has collected all the templates and configuration data in a recursive fashion, it proceeds to merge them at the corresponding anchor point for each of them as specified in the configuration file (metaconf).

The output of this stage is the final set of configuration changes to be applied to the network element 41 in an indivisible operation expressed in the “language” suitable for the device (command line interface, XML format, etc). This is ensured by the triggering configuration server 42 which selects the appropriate templates (in the appropriate “language”) for the network element to be included as URLs in the configuration file (metaconf).

### Target Configuration Self-Commission (Step 4)

The network element 41 commits the final set of configuration changes and the node becomes operational with the intended configuration.

Next, some specific embodiments of the invention are described in relation to the configuration file called metaconf.

### XML Based Metaconf Definition

Next the definition of the metaconf in XML format is described. The metaconf configuration file is composed of a number of template and configuration data XML tags.

The template XML tags have an attribute that holds the value of the anchor point in the configuration tree where the template is to be incrusted. The template tags contain the URLs that the node 41 has to access to download the template contents. The templates hold node specific commands (either CLI or XML) with references to data variables.

The configuration data XML tags contain the URLs that the node 41 has to access to download the value for data variables.

### CLI Based Metaconf Definition

Next the definition of the metaconf in CLI format is described. The metaconf configuration file is composed of a number of CLI commands that enable the definition of template URLs and their corresponding anchor points and the definition of configuration data URLs to access for data variables.

The templates at the specified URLs hold node specific commands (either CLI or XML) with references to data variables.

### File Transfer Based Metaconf Delivery (Applicable to Step 1)

Next the metaconf delivery by the triggering configuration server 42 to the network element 41 is described, based on a file transfer protocol (e.g. TFTP, FTP) as a result of a pull procedure (e.g. DHCP/BOOTP procedure).

The DHCP ACK to the Pull operation includes:
In the Next-Server DCHP Option the IP address of the triggering configuration server 42 and the file transfer protocol to be used (FTP/TFTP)
In the File-Name DHCP Option the path of the metaconf generated for the network element 41 by the triggering configuration server 42.

When receiving the DHCP ACK, the node reads the Next-Server and File-Name fields in the DHCP request and sends a File Transfer request to the server for the file that contains its metaconf.

### NETCONF Based Metaconf Delivery (Applicable to Step 1)

Next the metaconf delivery based on a NETCONF method invocation by the triggering configuration server 42 on the network element 41 is described.

The triggering configuration server 42 connects to the NETCONF server at the network element 41 and invokes a NETCONF method that accepts the contents of the metaconf as argument. This effectively delivers the metaconf to the node.

### TELNET/SSH Based Metaconf Delivery (Applicable to Step 1)

Next the metaconf delivery via an interactive command line session (Telnet/SSH) is described. Via such a session the metaconf definition is input to the network element 41.

### Delivery Script/NETCONF Based Metaconf Inspection (Applicable to Step 2)

Next, the execution of an internal script in the node 42 is triggered, once the metaconf definition has been delivered by the triggering configuration server 42. The script invokes a local NETCONF method that parses the metaconf and extracts the URLs to be accessed. The local NETCONF method is openly programmable to do the parsing.

### Delivery Script/CLI Based Metaconf Inspection (Applicable to Step 2)

Next, the execution of an internal script in the node 42 is triggered, once the metaconf has been delivered. The internal script itself parses the metaconf and extracts the URLs to be accessed.

### File Transfer Based Template/Confiquration Data Acquisition (Applicable to Step 2)

Next, the template/configuration data acquisition via a File Transfer protocol from a supporting configuration server 43 44 45 is described.

The tags at the metaconf contain URLs that specify a File Transfer protocol and all the details to access the required content (IP address of the supporting configuration server, file path, user, password, etc). The node 41 accesses the contents at the supporting configuration server 43 44 45 making use of the specified File transfer Protocol and credentials.

### NETCONF Based Template/Configuration Data Acquisition (Applicable to Step 2)

Next, the template/configuration data acquisition via the invocation of a remote NETCONF method at a supporting configuration server 43 44 45 is described.

The tags at the metaconf contain URLs that specify a NETCONF method to be invoked (e.g. get_template) in a remote supporting configuration server 43 44 45 (e.g. template repository IP address) and the arguments to get the desired contents (template name, configuration data file name or variable name). The node accesses the contents invoking the method at the remote supporting server with the specified arguments.

### DHCP Based Template/Confiquration Data Acquisition (Applicable to Step 2)

Next the template/configuration data acquisition via DHCP mechanisms is described.

The tags at the metaconf contain URLs that specify DHCP as the protocol to be used, the name of the server to accept as DHCP server.

### Web Service Based Template/Data Acquisition (Applicable to Step 2)

Configuration data is not restricted to be a file URL, other kinds of URLs are possible as well, such a Web Service URL providing the network device 41 a way to request its configuration data (or part of it) to an element in charge of assigning available resources (e.g. an auto-discovery server).

### NETCONF Based Target Configuration Composition (Applicable to Step 3)

Once all the templates/configuration data have been downloaded to the network element 41, a script in the network element 41 is triggered that invokes a local NETCONF method in the network element 41 that combines the templates at their corresponding anchor points as specified in the metaconf and substitutes the variables in the templates by their values as defined in the configuration data elements.

### Internal CLI Based Target Configuration Composition (Applicable to Step 3)

Once all the templates/configuration data have been downloaded to the network element 41, an internal script in the network element 41 is triggered that combines the templates at their corresponding anchor points as specified in the metaconf and substitutes the variables in the templates by their values as defined in the configuration data elements.

Next an Example of a Real Implementation of the Invention is Described. In Particular, a Prototype is Disclosed.

It has been implemented making use of Juniper EX-series routers. These routers have support for NETCONF methods that can be invoked as part of commit scripts. All these capabilities are packed commercially in the Juniper JUNOScript support.

Another feature of the EX series used for the aforementioned implementation is their auto-installation capabilities in a factory default configuration that enable the use of DHCP/TFTP procedures for installing an initial configuration in the router. In the prototype this initial configuration was a metaconf delivered by TFTP.

The metaconf definition was based on the apply-macros feature of the JUNOS software that enables the pasting of custom expressions in a configuration that are not interpreted by the router, but can eventually be used by some kind of local script. For the prototype, commit scripts were applied as part of the initial configuration. These commit scripts were invoked once the initial configuration (containing the metaconf as apply macro statements) was delivered to the equipment.

There were 2 of these commit scripts that were invoked sequentially after the initial configuration was autocommited as part of the autoinstallation feature. The first script was in charge of inspecting the metaconf (the apply macro statements in the initial configuration), parsing the URLs and downloading them (templates and configuration data). The second script was executed once the downloading was completed and was in charge of merging the templates at their anchor point with the values for the variables at the configuration data files and applying the final set of configuration changes.

As a summary, the prototype can be categorized as an implementation made up of the following embodiments or characteristics:
CLI based metaconf definition (as apply macro statements in JUNOS configuration)
File Transfer (TFTP) based metaconf delivery (as a result of the autoinstallation feature from a factory default configuration)
Commit script/NETCONF based metaconf inspection (making use of self-developed NETCONF method “download”)
FTP based template acquisition (making use of JUNOScript File Transfer NETCONF filecopy method inside “download” method)
FTP based configuration data acquisition (making use of JUNOScript File Transfer NETCONF filecopy method inside “download” method)
Commit script/NETCONF based Target Configuration composition (making use of self-developed NETCONF method “merge”)

Among the advantages of the invention, the following can be mentioned: Existing Network Management solutions are all based on a monolithic “push” model. The configuration is pushed in its entirety to the network device that merely commits the configuration changes. All the configuration logic resides on the NMS. This leads to an opaque design of the NMS who is in charge of:
Handling the pools of resources and assigning resources for the configuration data (e.g. IP addresses, VLAN Ids, etc)
Pre-knowledge of the equipment to be deployed (model, role, ports, points of connection, etc)
Selection of the templates to be used at different levels of the configuration tree (e.g. one template for global configuration, another for routing, another for uplink interfaces, another for user interfaces, . . . ) based on the knowledge about the equipment and its expected connection to the network
Combination of the configuration data and the templates to produce a complete new configuration change to send to the device

This opaque and monolithic design of the NMS leads to high costs because too much is in the control of just one piece of software. As a result, any subsequent change to accommodate new configurations in the network device is costly for the network operator because of the ad-hoc nature for its network of the NMS. The costs are very high even when the NMS has to deal only with equipment that is configured in a very similar way as is the case for the access nodes (DSLAMs, OLTs).

Not only costs to change the NMS are high, but the development time to incorporate new functionality in the network is as well. This leads to a higher Time-to-Market for the deployment of new services.

Well-known enhancements in network device processing capabilities allow for some “outsourcing” of the configuration logic of the NMS to the network device. However, this logic must be pre-stored in the network device and is still monolithic in the sense that it codes all the logic applicable to the whole configuration it is meant to change. Instead of pushing all the configuration to the network device, all the configuration data must be pushed to the network device that then runs the configuration logic, that must be pre-stored. That does not solve the problem, because the solution remains rigid and inflexible.

This monolithic approach to the NMS renders irrelevant the need for changing from a “push” model to a “pull” model where the network device asks for its configuration when it is connected to the network. The configuration produced by the NMS is so specific to that particular node that a technician in-field is required to check that each port is connected where it should or even to inform of what ports are being used for what purpose (uplink, downlink, etc) if that is not fixed beforehand. In addition to this, the NMS workflow takes so much time to produce a configuration for a specific node (mainly because the resource assignment depends on input from personnel of the network operator departments), that the advance in time achieved by a pull model is not worthy the change.

The conclusion is that to rollout new equipment, a qualified technician who knows how to configure the equipment (at least a minimal configuration for making it available to the NMS) and where to connect it (this port as uplink, etc) must be sent to personally do it.

In general, the main advantage of the present invention is that enables the NMS “deconstruction” into separate entities with exposed modules and interfaces that are upgradable independently of each other. The remaining NMS becomes simplified, therefore reducing its costs and improving the time to market to include modifications in the network configuration:
As regards the resource assignment, thanks to this invention, the NMS can just simply provide to the network device the URL of an autodiscovery server as configuration data, instead of handling the resource assignment in the NMS. This outsourcing of the resource assignment from the NMS has the advantage of simplification of the NMS.
Thanks to this invention, the NMS has no longer to deal with the merging of configuration data and templates because it is done by the network device. This provides additional simplification of the NMS.
The only functionality kept by the NMS is the selection of the templates to be used per model/role, while the actual storage and versioning of the templates is separate from the NMS.
A change in the network architecture does not require a new version of the NMS, just new templates for the new architecture.

Another advantage is that the invention, used in conjunction with pull technologies like DHCP (not covered by this patent application) can provide effective auto-configuration of the network equipment reducing the deployment costs of network equipment (less qualified personnel).

On the other hand, the network device is only required to be augmented with the following capabilities:
Support of the metaconf configuration file, preferably defined in XML format and implemented as an NETCONF RPC method (therefore NETCONF support)
The metaconf configuration file implies processing capability in the network device so that it can combine the downloaded templates with the data. The main idea behind the metaconf configuration file is that the processing capabilities are limited to the “blind” merging of templates that include references to variables with the values of these variables obtained as configuration data URLs. No ad-hoc methods other than the target configuration composition based on these rules are required at the network element.

This new requirements to the network device are in-line with the processing power of state-of-the-art equipment used today in operator IP networks.

The invention is obviously not limited to the specific embodiments described herein, but also encompasses any variations that may be considered by any person skilled in the art (for example, as regards the choice of components, configuration, etc.), within the general scope of the invention as defined in the appended claims.

1-8. (canceled)

9. A method for composing configuration changes to be applied to a network element in a distributed way, the method being characterized in that it comprises the steps of:
at a first server, generating a configuration file and signaling the content of said configuration file to the network element;
at said network element, inspecting content of said configuration file;
according to said content of said configuration file, contacting by said network element a plurality of supporting servers and downloading from each of said supporting servers partial pieces of the configuration changes to be applied to the network element;
combining said partial pieces of configuration changes at said network element, thus obtaining a set of resulting configuration changes;
applying at said network element said set of resulting configuration changes.

10. The method of claim 9, wherein said step of signaling a configuration file to the network element is either triggered by the network element itself requesting its configuration to the said first server or determined and triggered by a Network Management System configuration logic.

11. The method of claim 9, wherein said configuration file comprises a set of URLs for configuration templates and configuration data, wherein said configuration templates include configuration commands with references to variables and the configuration data define values for the variables referenced in the configuration templates.

12. The method of claim 11, wherein said configuration file is configured to identify an anchor point of each template in a configuration tree of the network element.

13. The method of claim 11, wherein according to the content of the configuration file, the network element produces its own complete set of configuration changes by merging the templates at their corresponding anchor point with the configuration data.

14. A system comprising a first server, a network element and a plurality of supporting servers, said system being configured for carrying out the steps of the method according to claim 9.

15. A computer program comprising computer program code means adapted to perform the steps of the method according to claim 9, when said program is run on a computer, a digital signal processor, a field-programmable gate array, an application-specific integrated circuit, a micro-processor, a micro-controller, or any other form of programmable hardware.
